(19) United States
(12) Patent Application Publication
(10) Pub. No.: US 2014/0297788 A1
(43) Pub. Date: Oct. 2, 2014

(54) APPARATUS AND METHOD FOR CONTENT DISTRIBUTION

(71) Applicant: KABUSHIKI KAISHA TOSHIBA, Tokyo (JP)

(72) Inventors: Takayoshi Ito, Kanagawa-ken (JP); Seiichiro Horikawa, Kanagawa-ken (JP); Koji Akita, Kanagawa-ken (JP)

(73) Assignee: KABUSHIKI KAISHA TOSHIBA, Tokyo (JP)

(21) Appl. No.: 14/102,231

(22) Filed: Dec. 10, 2013

(30) Foreign Application Priority Data
Apr. 2, 2013 (JP) 2013-077280

(51) Int. Cl. H04L 29/08

(52) U.S. Cl. CPC H04L 67/10
USPC 709/217

(57) ABSTRACT

Apparatus for content distribution includes a distribution processor configured to distribute first data to a terminal of a visitor at a first site of an event, the first data comprising first information regarding a content related to the event and a content distribution processor configured to distribute, at a second site other than the first site, the content to the terminal when second data is determined as valid in relation to the first data by the content distribution processor, the second data originating from the terminal and comprising second information.

### CROSS-REFERENCE TO RELATED APPLICATION

This application is based upon and claims the benefit of priority from Japanese Patent Application No. 2013-077280 filed on Apr. 2, 2013, the entire contents of which are incorporated herein by reference.

### FIELD

Embodiments described herein relate generally to an apparatus and a method for content distribution.

### BACKGROUND

Recently, a content order method that the audience of the theater can order a content related to the movie has been proposed. In this method, the mobile phone of the audience is activated as an ordering apparatus by taking pre-determined procedure and the audience can order the content after or during watching movie at the theater or any other places.

However, the conventional method lacks the ability to pull in more customers at a target place because it distributes the content at places that have no connection with the event itself.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a pattern diagram of a relationship between site A and site B according to a first embodiment.

FIG. 2 is a block diagram of a content distribution apparatus according to the first embodiment.

FIG. 3 is an example of a content database according to the first embodiment.

FIG. 4 is a flowchart illustrating processing of the content distribution apparatus according to the first embodiment.

FIG. 5 is a flowchart illustrating processing of the content distribution apparatus according to a second embodiment.

FIG. 6 is a flowchart illustrating processing of the content distribution apparatus according to a third embodiment.

FIG. 7 shows a hardware component of the content distribution apparatus.

### DETAILED DESCRIPTION

According to one embodiment, an apparatus for content distribution contains a distribution processor and a content distribution processor. The distribution processor distributes first data to a terminal of a visitor at a first site of an event. The first data is comprising first information regarding a content related to the event. The content distribution processor distributes, at a second site other than the first site, the content to the terminal when second data is determined as valid in relation to the first data by the content distribution processor. The second data is originating from the terminal and comprising second information regarding the content.

Various embodiments will be described hereinafter with reference to the accompanying drawings, wherein the same reference numeral designations represent the same or corresponding parts throughout the several views.

### THE FIRST EMBODIMENT

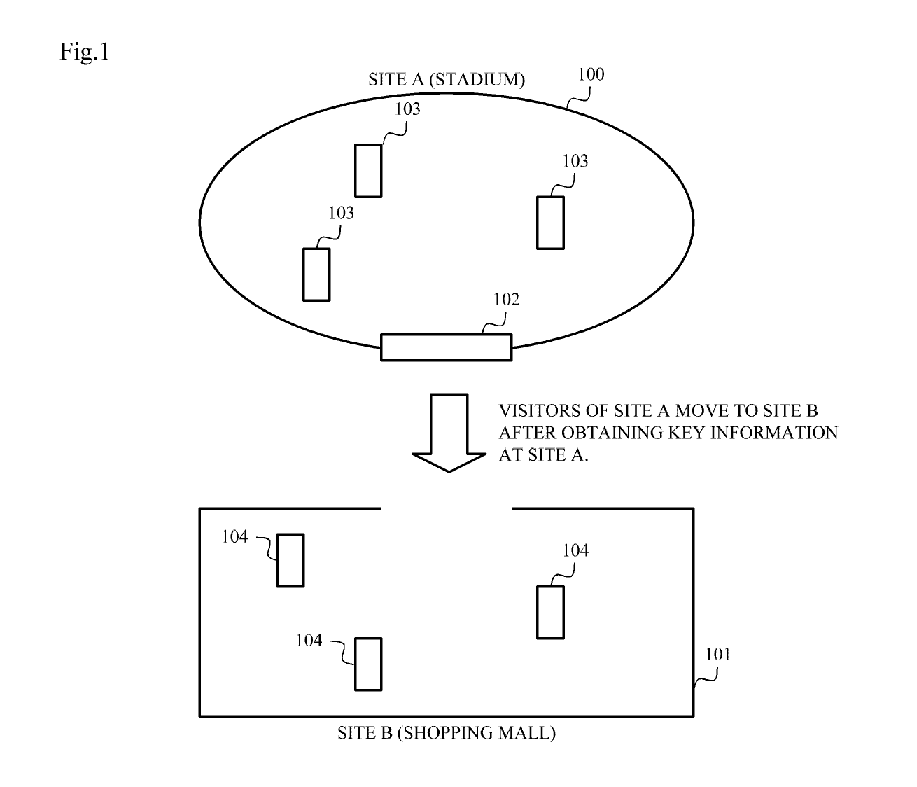

The first embodiment describes a content distribution apparatus that distributes a content related to an event (related content). The event is took place at site A and the related content is distributed at site B other than site A. FIG. 1 is a pattern diagram of a relationship between site A and site B. The site A is a stadium for a baseball game and concert, etc. The entrance of site A is managed by a gate 102. The site B is a shopping mall adjacent to site A. The event and related products are sold at site B. The site B has no gate and it is open to any visitors (open door site). In site B, it is less likely to be a case that many visitors rush to the narrow gate at the same time compared to site A because there is no gate in site B.

The content distribution apparatus according to the first embodiment distributes key information to a mobile terminal 103 owned by a visitor who attends the event at site A. The key information is needed to obtain the related content at site B and it is distributed by utilizing wireless network. Then, the content distribution apparatus distributes, by utilizing short-range wireless communication, the related content to a mobile terminal 104 of a visitor who moves to site B after finishing the event. Here, the related content is distributed to the mobile terminal 104 that has stored valid key information. It means that the related content is distributed to the mobile terminal that has obtained the key information at site A. Therefore, the related content can be a specific benefit to the visitors of the event at site A.

For example, when a baseball game is took place at a stadium (site A), the content distribution apparatus distributes highlight movie of the baseball game at a shopping mall (site B) as the specific benefit to the visitor of the baseball game.

In this way, the content distribution apparatus according to this embodiment distributes the key information at site A, and after that, at site B, the content distribution apparatus distributes the related content to the mobile terminal that has stored the key information. Accordingly, it makes it possible to pull in more customers at site B (target site) by introducing visitors of site A to site B by utilizing the related content as the specific benefit.

(Function)

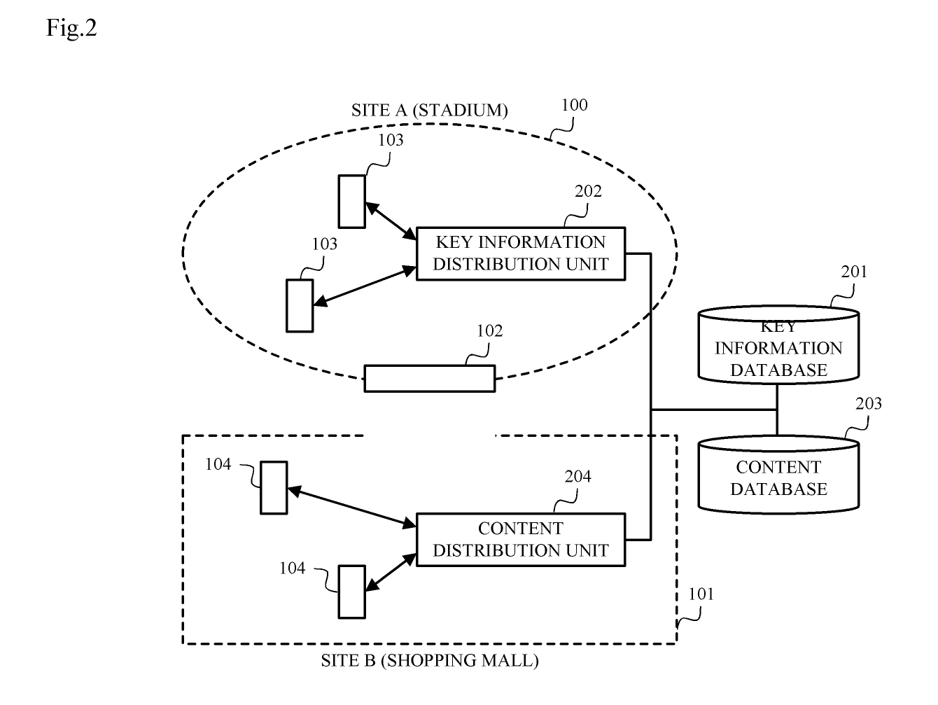

FIG. 2 is a block diagram of the content distribution apparatus. The content distribution apparatus contains key information database 201, key information distribution unit 202, a content database 203 and a key information distribution unit 204. The content distribution apparatus distributes key information K to mobile terminals of visitors at site A. Then, the content distribution apparatus obtains key information J from the mobile terminal of the visitor who moves to site B from site A. Then, the content distribution apparatus distributes the related content if the key information J is valid in relation to the key information K.

The key information database 201 electrically stores the key information K or other information needed to create the key information K. The key information K is information that is needed to obtain the related content at site B.

The key information database 201 can store code such as “ABC” as the key information K. The key information database 201 can also store a pre-determined rule such as “ID of mobile terminal multiplied by five” as information to create the key information K. In this case, the information created based on the pre-determined rule becomes the key information K.

The key information distribution unit 202 distributes the key information K at site A where the event is took place. The key information distribution unit 202 distributes the key information K to mobile terminals of visitors by utilizing wireless network such as wireless LAN.

The key information distribution unit 202 can distribute the key information K as a specific benefit to the visitors of site A by limiting transmission area of the wireless LAN within site A. The transmission speed of the wireless LAN is not deteriorated because the size of the key information is small.

The key information distribution unit 202 can distribute the key information K by utilizing short-range wireless communication such as NFC (near field communication). The distribution of the key information K can be limited to the mobile terminal of the visitor because the transmission range of the short-range wireless communication is limited from a few centimeters to a few meters.

The key information distribution unit 202 reads the key information K from the key information database 201 when the key information database 201 stores the key information K itself. On the other hand, when the key information database 201 stores the pre-determined rule such as “ID of mobile terminal multiplied by five”, the key information distribution unit 202 creates the key information K based on the pre-determined rule. For example, when the ID of a mobile terminal T obtained by wireless communication is 10, the key information distribution unit 202 distributes “50” to the mobile terminal T as the key information K. The “50” is created by the rule “10 (ID of the mobile terminal T) multiplied by five”.

The content database 203 electrically stores the related contents to the event at site A. In this embodiment, the related contents are multimedia data consist of movie, picture and sound. The file formats of the multimedia data are such as MPEG, JPEG and MP3, etc.

When a baseball game is took place at site A, highlight movie can be created as the related content during or after finishing the baseball game. The introduction movie of each player can be created as the related content before starting the baseball game.

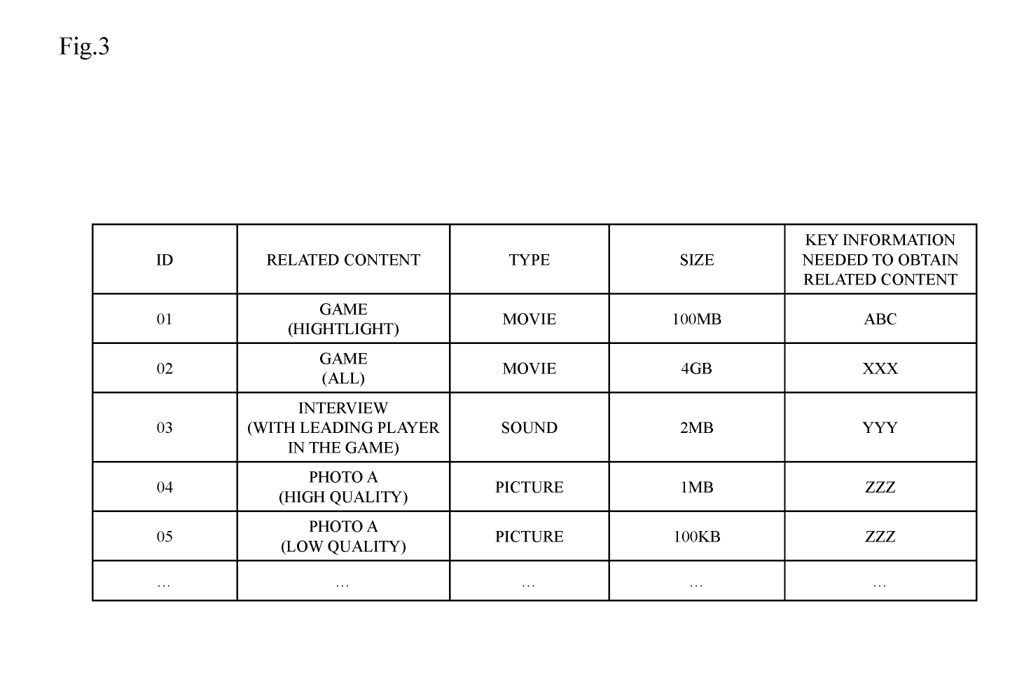

In FIG. 3, the content database 203 stores the related contents with the connection to key information. In FIG. 3, for example, the related content “GAME (HIGHLIGHT) ” of “ID01” is connected to the key information “ABC”.

The key information distribution unit 204 obtains the key information J from the mobile terminal of the visitor at site B. Then, the key information distribution unit 204 determines whether the key information J is valid or not in relation to the key information K distributed by the key information distribution unit 202. When it is determined as valid, the key information distribution unit 204 distributes the related content to the mobile terminal of the visitor. When it is determined as invalid, the key information distribution unit 204 does not distribute the related content.

For the distribution of the related content, short-range wireless communication such as NFC and TRANSFERJET (registered trademark) can be utilized. Because of the limited transmission range of the short-range wireless communication, the content distribution apparatus can introduce the visitors to the specific location where the access point of the short-range wireless communication is located. Moreover, by utilizing one-to-one communication, there is no need to care interference with the other mobile terminals.

The key information distribution unit 204 obtains the key information J from the mobile terminal of the visitor at site B. Then, the key information distribution unit 204 determines whether the key information J is valid or not in relation to the key information K distributed by the key information distribution unit 202.

When the key information distribution unit 202 distributes “ABC” as the key information K, the key information distribution unit 204 determines whether the key information J obtained from the mobile terminal is identical to “ABC”. When it is identical (the key information K equals to the key information J), the key information distribution unit 204 determines that the key information J is valid. When it is not identical (the key information K and the key information J are different), the key information distribution unit 204 determines that the key information J is invalid.

When the key information distribution unit 202 distributes the key information K created based on the pre-determined rule such as “ID of mobile terminal multiplied by five” store in the key information database 201, the key information distribution unit 204 determines whether the key information J is matched to the pre-determined rule. In this example, the key information distribution unit 204 obtains the ID of the mobile terminal and checks whether “The key information J divided by the ID of the mobile terminal” becomes equal to 5.

When the key information J is valid, the key information distribution unit 204 distributes the related content connected to the key information J to the mobile terminal that has sent the key information J to the key information distribution unit 204. In FIG. 3, for example, if the key information J from the mobile terminal is “ABC”, the key information distribution unit 204 distributes the related content “GAME (HIGHLIGHT)” of “ID01” to the mobile terminal.

(Flow Chart)

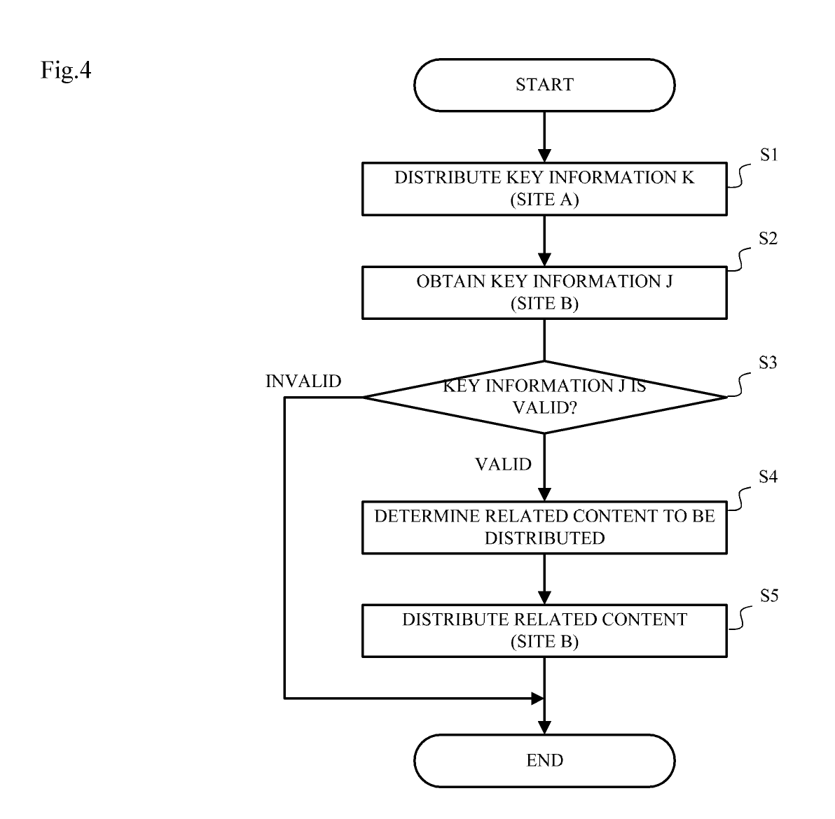

FIG. 4 is a flow chart illustrating processing of the content distribution apparatus according to the first embodiment.

At S1, the key information distribution unit 202 distributes the key information K to the mobile terminal of the visitor at site A. The mobile terminal stores the key information K in its memory.

Before taking S1, at site A, the content distribution apparatus can notify the visitors with the distribution of the key information K, the timing of the distribution and the location of site B. The key information K can be distributed during or after finishing the event.

At S2, the key information distribution unit 204 obtains the key information J from the mobile terminal of the visitor at site B. S2 is executed at site B. The mobile terminal reads the key information K from its memory and sends it to the key information distribution unit 204.

At S3, the key information distribution unit 204 determines whether the key information J obtained at S2 is valid or not. The validity is determined in the relation to the key information K distributed as S1. When it is determined as invalid, the content distribution apparatus finishes the process without distributing the related content. When it is determined as valid, the process moves to S4.

At S4, the key information distribution unit 204 determines the related content to be distributed by referring the key information J obtained at S2 and the content database 203.

At S5, the key information distribution unit 204 distributes the related content determined at S4 to the mobile terminal that has sent the key information J to the key information distribution unit 204. S5 is executed at site B.

In this way, the content distribution apparatus according to this embodiment distributes the key information at site A, and after that, at site B, the content distribution apparatus distributes the related content to the mobile terminal that has stored the key information. Accordingly, it makes it possible to pull in more customers at site B (target site) by introducing visitors of site A to site B by utilizing the related content as the specific benefit.

Moreover, by distributing the related content at site B other than site A, it encourages the visitors of site A to go out from site A. It makes it possible to start post works promptly such as cleaning and security check, etc.

### THE SECOND EMBODIMENT

The second embodiment describes a content distribution apparatus that determines key information K based on an action history of the visitor such as visit frequency. Accordingly, it makes it possible to distribute the related content based on an attribute of each visitor. For example, the content distribution apparatus can distribute the key information K needed to obtain a high-value-added related content to the visitor who attends events frequently.

The block diagram of the content distribution apparatus according to the second embodiment is the same as the first embodiment in FIG. 2.

(Flow Chart)

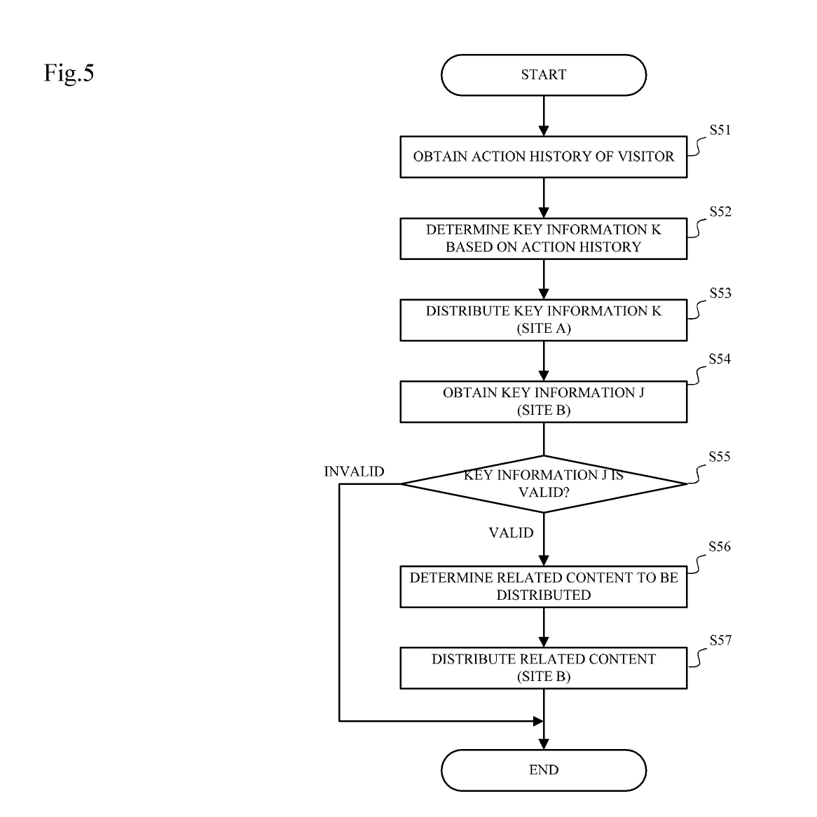

FIG. 5 is a flow chart illustrating processing of the content distribution apparatus according to the second embodiment.

At S51, the key information distribution unit 202 obtains an action history from the mobile terminal of the visitor. Here, the action history is such as buying history, location information, visit frequency and member information, etc.

The key information distribution unit 202 obtains the action history via wireless network. In other ways, the key information distribution unit 202 reads the action history from an action history database equipped to the content distribution apparatus in order to store the action history electrically. The key information distribution unit 202 can update data in the action history database.

At S52, the key information distribution unit 202 determines the key information K based on the action history obtained at S51.

In FIG. 3, for example, the key information distribution unit 202 can distribute both “ABC” and “XXX” to the visitor whose visit frequency exceeds ten. In addition, the key information distribution unit 202 distributes only “ABC” to the other visitors. Accordingly, the key information distribution unit 204 can distribute “GAME (ALL)” as well as “GAME (HIGHLIGHT)” as the specific benefit for the visitor who visits events frequently.

In other ways, the key information distribution unit 202 can distribute the key information K which enables to obtain all related contents to the visitor whose total purchase amount at site A exceeds ¥10,000.

The process of the steps from S53 to S57 is the same as the first embodiment.

The content distribution apparatus according to this embodiment determines the key information K based on the action history of the visitor such as visit frequency. Accordingly, it makes it possible to distribute the related content based on the attribute of each visitor.

### THE THIRD EMBODIMENT

The third embodiment describes a content distribution apparatus that determines the related content to be distributed based on an action history of the visitor such as visit frequency. Accordingly, it makes it possible to distribute the related content based on an attribute of each visitor. For example, the content distribution apparatus can distribute a high-value-added related content to a visitor who attends events frequently.

The block diagram of the content distribution apparatus according to the third embodiment is the same as the first embodiment in FIG. 2.

(Flow Chart)

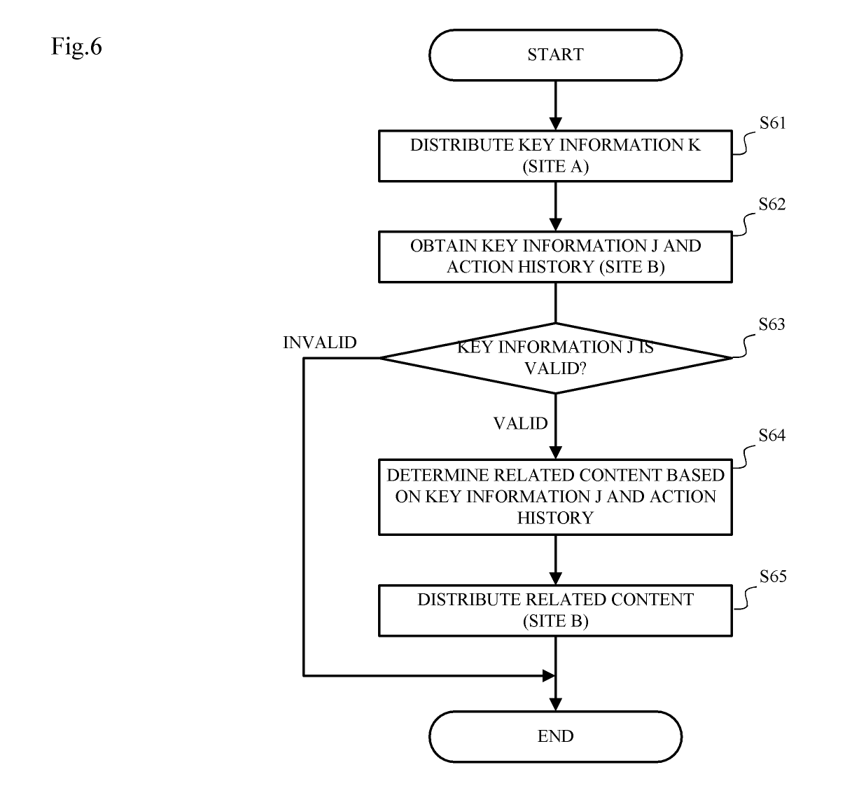

FIG. 6 is a flowchart illustrating processing of the content distribution apparatus according to the third embodiment.

At S61, the key information distribution unit 202 distributes the key information K to the mobile terminal of the visitor at site A.

At S62, the key information distribution unit 202 obtains both the key information J and the action history of the visitor.

At S63, the key information distribution unit 204 determines whether the key information J obtained at S62 is valid in relation to the key information K distributed at S61. When it is determined as invalid, the content distribution apparatus finishes the process without distributing the related content. When it is determined as valid, the process moves to S64.

At S64, the key information distribution unit 204 determines the related content to be distributed based on the key information J and the action history obtained at S62.

For example, when the key information J determined as valid at S63 is “ZZZ”, “PHOTO A (HIGH QUALITY)” and “PHOTO A (LOW QUALITY)” in FIG. 3 become a candidate to be distributed. In this case, the key information distribution unit 204 can select “PHOTO A (HIGH QUALITY)” as the related content only when total purchase amount of the visitor exceeds ¥1,000.

In other ways, the key information distribution unit 204 can convert the key information J to key information C that enables to obtain a high-value-added related content based on the buying history. Then, the content distribution unit 204 can determine the related content based on the key information C.

For example, the key information distribution unit 204 can convert the key information J to the key information C when the visitor purchases goods at site B by utilizing settlement function of his/her mobile terminal. In other ways, the key information distribution unit 204 can distribute the key information C converted from the key information J to the mobile terminal when the key information distribution unit 204 obtains the notice of complete of payment as the action history.

In other ways, the mobile terminal can convert the key information J to the key information C by utilizing a pre-determined rule notified from the key information distribution unit 204. The mobile terminal can obtain the more high-value-added related content by sending the key information C instead of the key information J.

The trigger to create the key information C can be movement to a specific place, connection with a specific terminal, and a lapse of time, etc.

In this way, the content distribution apparatus according to this embodiment determines the related content to be distributed based on an action history of the visitor. Accordingly, it makes it possible to distribute the related content based on an attribute of each visitor. Moreover, the content distribution apparatus encourages the visitor to purchase goods at site B by converting the key information J based on the purchase history such as total purchase amount.

(The First Variation)

The key information distribution unit 204 can determine the related content based on a communication function of the mobile terminal that has sent the key information J.

For example, when the key information distribution unit 202 has distributed “ZZZ” as the key information K and the key information distribution unit 204 obtains “ZZZ” from the mobile terminal as the key information J, the key information distribution unit 204 determines to distribute the related content because the key information J is valid. In FIG. 3, there are two related contents of “ID04” and “ID05” corresponding to “ZZZ”. In this case, the key information distribution unit 204 can select the related content based on a communication function of the mobile terminal that has sent the key information J. When the mobile terminal has a high-speed short-range wireless communication function such as TRANSFERJET (registered trademark), the key information distribution unit 204 distributes the picture of “ID04” with high quality and large volume. On the other hand, when the mobile terminal has only a low-speed short-range wireless communication function, the key information distribution unit 204 distributes the picture of “ID05” with low quality and small volume.

The communication function of the mobile terminal can be identified by utilizing connection request, acknowledgement and inquiry to the mobile terminal, etc. Moreover, the key information distribution unit 204 can distribute URL to the related content when the mobile terminal has only a low-speed short-range wireless communication function.

In this way, the key information distribution unit 204 can determine the related content based on a communication function of the mobile terminal. Accordingly, it makes it possible to avoid a case that the content distribution unit 204 tries to distribute large volume related content to the mobile terminal with only a low-speed communication function and transmission channel and a sending terminal of the related content are occupied for long seconds.

(The Second Variation)

The site A can be any site whose entry is managed such as auditorium, event site, entertainment park and corporate office building, etc. The site B can be any open door site such as supermarket, department store, concourse, lobby, open space and ground, etc.

(The Third Variation)

The key information K, J and C can be any type of key information that prevents unauthorized access to the related contents by the visitor who does not obtain appropriate key information at site A. The commonly-used authentication technique such as public key encryption can be utilized to prevent unauthorized access.

(Hardware Component)

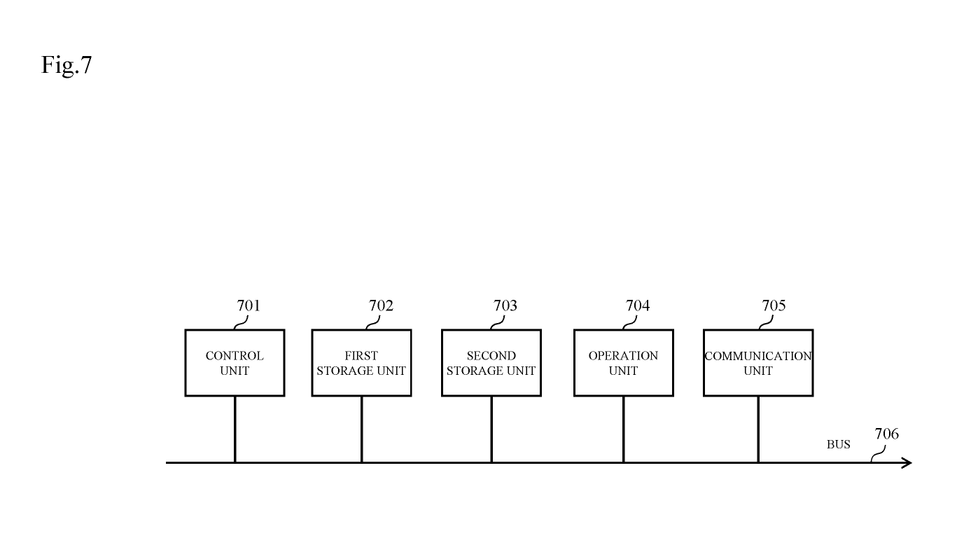

The content distribution apparatus is composed of hardware using a regular computer shown in FIG. 7. This hardware contains a control unit 701 such as a CPU (Central Processing Unit) to control the entire computer, a first storage unit 702 such as a ROM (Read Only Memory) and/or a RAM (Random Access Memory) to store various kinds of data and programs, a second storage unit 703 such as a HDD (Hard Access Memory) and/or a CD (Compact Disk) to store various kinds of data and programs, an operation unit 704 such as a keyboard, a mouse, and/or a touch screen to accept a user's indication, a communication unit 705 to control communication with an external apparatus, and a bus 706 to connect the hardware elements.

In such hardware, the control unit 701 executes one or more programs stored in the first storage unit 702 (such as the ROM) and/or the second storage unit 703. As a result, the functions of the key information database 201, the key information distribution unit 202, the content database 203 and the key information distribution unit 204 are realized.

The key information distribution unit 202 and the key information distribution unit 204 communicate with the mobile terminal of the visitor via the communication unit 705. The communication between the mobile terminal and the communication unit 705 of the content distribution apparatus can be realized by transmitting and receiving data including at least one of key information, the related content and any other information. The communication unit 705 can handle wide-area wireless communication such as wireless LAN, wireless cellular network such as LTE, and short-range wireless communication such as NFC, TRANSFERJET (registered trademark) and millimeter-wave communication.

The key information database 201, the content database 203 and the action history database can utilize the same second storage unit 703 for storing information, or each can have its own second storage unit 703.

The content distribution apparatus can be consisted of more than one computer terminals. For example, the key information database 201 and the key information distribution unit 202 can be consisted of one computer terminal X located at site A. In addition, the content database 203 and the key information distribution unit 204 can be consisted of one computer terminal Y located at site B. In this case, the computer terminal X and Y communicate with each other by utilizing its communication unit 705.

Moreover, the functions of the key information distribution unit 202 and the key information distribution unit 204 can be realized by utilizing the computer terminals located at site A and B respectively. And, the other functions are realized by utilizing a computer terminal Z located at other than site A and B.

The mobile terminal of the visitor can be any types of terminals with wireless communication function such as smartphone, tablet, laptop, slate PC and portable music player.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any non-transitory computer readable medium or computer readable storage medium, which is configured to store a computer program for causing a computer to perform the processing described above, can be used.

Furthermore, based on an indication of the program installed from the memory device to the computer, OS (operation system) operating on the computer, or MW (middle ware software), such as database management software or network, can execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices can be included in the memory device.

A computer can execute each processing stage of the embodiments according to the program stored in the memory device. The computer can be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the invention. Indeed, the novel embodiments described herein may be embodied in a variety of other forms, furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An apparatus for content distribution, comprising:
a distribution processor configured to distribute first data to a terminal of a visitor at a first site of an event, the first data comprising first information regarding a content related to the event; and
a content distribution processor configured to distribute, at a second site other than the first site, the content to the terminal when second data is determined as valid in relation to the first information by the content distribution processor, the second data originating from the terminal and comprising second information regarding the content.

2. The apparatus according to claim 1, wherein
the first information and the second information are key information needed to obtain the content.

3. The apparatus according to claim 1, wherein
the distribution processor distributes the first data based on an action history of the visitor.

4. The apparatus according to claim 1, wherein
the content distribution processor determines the content to be distributed base on an action history of the visitor and the second data.

5. The apparatus according to claim 1, wherein
the content distribution processor converts the second data to third data based on an action history of the visitor and determines the content to be distributed based on the third data.

6. The apparatus according to claim 1, wherein
entry of the visitor is managed in the first site,
the second site is an open door site.

7. The apparatus according to claim 1, wherein
the content distribution processor distributes the content to the terminal by utilizing short-range wireless communication.

8. The apparatus according to claim 1, wherein
the content distribution processor determines the content to be distributed based on a communication function of the terminal.

9. The apparatus according to claim 1, wherein
the first information and the second information are identical.

10. A method for content distribution, comprising:
distributing, first data to a terminal at a first site of an event, the first data comprising first information regarding a content related to the event; and
distributing, at a second site other than the first site, the content to the terminal when second data is determined as valid in relation to the first data, the second data originating from the terminal and comprising second information regarding the content.
